(19) United States
(12) Patent Application Publication
(10) Pub. No.: US 2004/0191435 A1
(43) Pub. Date: Sep. 30, 2004

(54) Unit forming a stocking-like layer on stocking-less legs

(75) Inventor: Yoshiumi Hamada, Ichinomiya-City (JP)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Nissin Medico Co., Ltd.

(21) Appl. No.: 10/759,233

(22) Filed: Jan. 20, 2004

(51) Int. Cl. F16L 1/00

(52) U.S. Cl. 428/34.1

(57) ABSTRACT

The present invention relates to a unit including a composition for forming a stocking-like layer which can be regarded as a garment by spray-jetting on stocking-less legs (of females), more particularly, it relates to a unit forming a stocking-like layer on stocking-less legs, which is composed of a combination of a container formed in a can or a steel bottle in which a coloring agent selected from pigments, dyes, pearly lusters, silk powder and fillers, a cosmetic and a propellant are housed as an aerosol and an illustrative medium made up of descriptive text, images and/or illustrative voice which informs users that a stocking-like layer. And, by forming the stocking-like layer on the stocking-less legs, an appearance as if stockings are worn is obtained even when not wearing conventional stockings, and when wearing sandal type shoes, the beauty of toes, particularly the beauty of nail art pedicure, particularly painting, is not spoiled, and freedom to wear sandal-like shoes where toes are exposed can be obtained by females (as well as males) who utilize them.

### BACKGROUND OF THE INVENTION

1. Field of the Invention

The present invention relates to a unit forming a stocking-like layer on stocking-less legs, more particularly, it relates to a unit including a composition for forming a stocking-like layer which can be regarded as a garment by spray-jetting on stocking-less legs (of females). By forming the stocking-like layer on the stocking-less legs, an appearance as if stockings are worn is obtained even when not wearing conventional stockings, and freedom to wear sandal-like shoes where toes are exposed can be obtained by females (as well as males) who utilize them.

2. Description of the Prior Art

Cosmetics which form a layer to mask scarring, bruises or shade change parts on the surface of skin in make-up technology are termed foundations.

As constituents which compose the foundation, for example, widely utilized are various substances such as fine particle agents for beauty effects such as base agents for layer formation, skin protecting agents, coloring agents, UV absorbents and silk powder, and other various aids, (e.g., see Japan Patent No.3,470,806). To form the layer as the foundation, known are a spray mode (e.g., see Japan Patent No. 2,812,690 and Japan Patent Pre-Publication No.2003-19,027), a coating mode by static electricity (e.g., see Japan Patent Pre-Publication No.H05-194,145) and the like in addition to ordinary coating technology.

However, it has not been known to form a layer which can be also regarded as a garment by a spray jet in response to stocking-less legs. A line of thought that the layer formed on the stocking-less legs by the unit of the present invention has an appearance as if stockings are worn to free females from wearing conventional stockings knitted with fine thread has not been known anywhere other than in the present invention.

### SUMMARY OF THE INVENTION

Excluding severe cold places where people do not wear skirts which expose parts of feet (legs) and severe hot places, for many females living in developed areas, it is disgraceful to be stocking-less and there is an etiquette to wear the stockings throughout the year. However, it is also of a woman's mind to show a beautifully finished pedicure, particularly nail art of toe nails, and a style of sandals on stocking-less legs are the expression. However, when wearing stockings, in consideration of rules of etiquette, the toes are hidden and thus the elaborate nail art comes to nothing.

When wearing sandal-shaped open shoes, not only is the pedicure beautifully crafted on toes hidden by extremity parts of the stockings, but also parts of the stockings are often scratched and torn. Thus, until replacement with new stockings, a female must bear such embarrassment for some time.

The most important objective of the present invention is to free females (males in some cases) who are bothered by the occurrence of the above cases from wearing stockings, and to disclose a unit comprising a composition for forming a layer which appears like the stockings on stocking-less legs by spray jet.

Another objective of the present invention is to disclose a unit comprising a spray composition for forming a stocking-like layer on stocking-less legs, capable of obtaining beautiful leg effects whereby pedicure is visible at simultaneously while stockings appear to be worn.

### BRIEF DESCRIPTION OF THE DRAWINGS

FIG. 1 is isometric view showing one example of the unit according to the present invention.

### DETAILED DESCRIPTION OF PREFERRED EMBODIMENT(S)

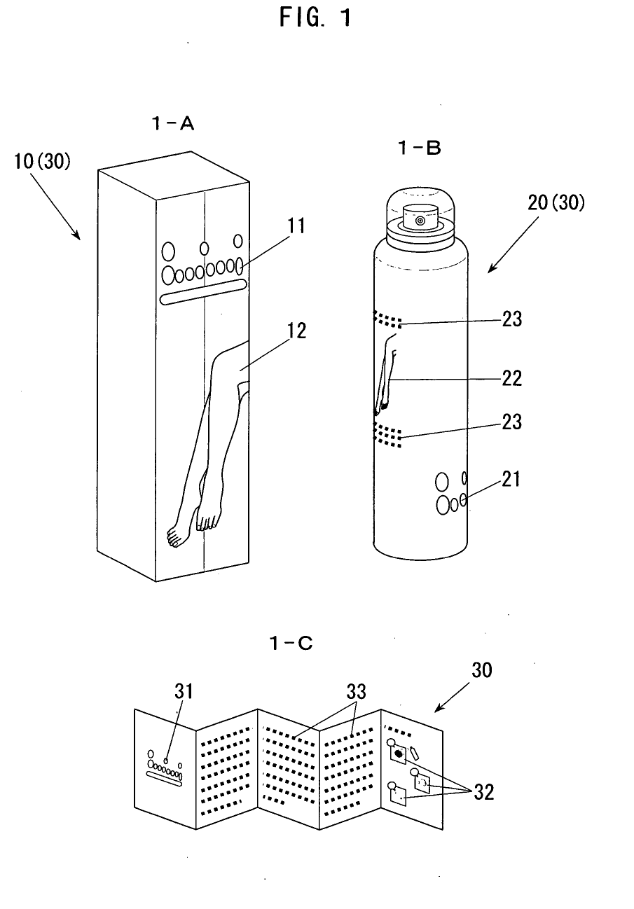

According to FIG. 1, one representative example of the unit of the present invention is explained as follows.

The unit according to the present invention is composed of an outer package container 10 (see FIG. 1-A in FIG. 1), a container 20 in which a composition for a spray jet is housed (see FIG. 1-B in FIG. 1), and an illustrative medium 30 (see FIG. 1-A, 1-B and 1-C in FIG. 1).

The outer package container 10 is a paper or plastic box as shown in 1-A of FIG. 1, and is covered with transparent package paper for placing on the market. It is preferable that descriptive text 11 including naming such as “air stockings”, “powder stockings”, “spray stockings” or “non-wear stockings”, an image section 12 where a stocking-like layer is formed on stocking-less legs, and warnings for use, which are not shown in FIG. 1, are displayed on a part or an entirety of the outer surface.

As the descriptive text 11, it is preferable to directly inform on-lookers that the stocking-like layer is formed on the stocking-less legs only by a spray jet and it is not necessary to wear the stockings.

With respect to the image section 12, it is required that a state where the stocking-like layer is formed on the stocking-less legs is represented. It is particularly important that a state of pedicure on the toes including nail art is beautifully depicted. Only stocking-less legs are depicted in the mode shown in FIG. 1, but it is more preferable that a state where at least one foot wears a sandal is depicted.

An outer shape of the outer package container is not limited to a rectangular column as shown in FIG. 1, and can be made into various shapes such as a circular column and hexagonal column.

The container 20 in the unit according to the present invention is made up of a can or a steel bottle in which a composition to be spray-jetted is housed and as a structure for the spray jet, and required to have strength to endure pressure of contained gas. As materials which compose the can or the steel bottle and the structure thereof or the structure of a nozzle to be equipped, it is possible to employ various configurations known in the art or of commercially available articles having the structure for the spray jet known in the art.

On the surface of the container 20, descriptive text 21 including a naming such as “air stockings”, “powder stockings”, “spray stockings” or “non-wear stockings”, an image section 22 where a stocking-like layer is formed on the stocking-less legs, and a use method or warnings 23 for uses which are not shown in the figure are displayed. A reason why these are necessary is that there is a possibility that a user discards the outer package container 10 after buying and taking out the container 20. Even in such a case, the content can be determined by the descriptive text 21, the image section 22 and the warnings on the surface of the container 20.

The illustrative medium 30 is for recording the descriptive text 31 to the effect that the composition housed in the container which forms the present unit forms the stocking-like layer only by spray-jetting on the stocking-less legs, the descriptive text 33, illustrative images 32 and/or if necessary illustrative voice which informs users of the use method thereof, and further the warnings for use. It is preferable that the descriptive text and the illustrative voice comprise a phrase such as “air stockings”, “powder stockings”, “spray stockings” or “non-wear stockings”. It is preferable to have a phrase with impact which eliminates the conventional stereotypical concept as the stockings, i.e., the concept that the stockings are those knitted with silk or fine synthetic resin yarn.

Although a foldable paper piece is shown as the illustrative medium 30 in FIG. 1-C in FIG. 1, a plastic plate, a wooden plate or a metallic plate may be utilized in place of such a paper piece. Additionally, FIG. 1-A and 1B represent that the outer package container 10 and the container 20 serve as the illustrative medium 30, respectively.

Additionally, as the illustrative medium 30, it is possible to utilize a voice recording/reproducible medium alone or in combination with another illustrative medium. Preferably utilized are those media where a voice recording is digitally performed in an integrated circuit packaged onto a chip, not as a hard medium such as a tape and disc. When the recording and reproducing capacity is limited to several minutes, they can be utilized very inexpensively. With a medium, which has a large capacity for recording and reproducing, vacant capacity can be utilized as advertisement media for not only one's own company but also for other companies and businesses, and further for music, movies and other advertising campaigns. Therefore, if secondary profits can be obtained from these, it is possible to lower the retail price of the entire unit.

The illustrative medium 30 can be housed along with the container 20 in the outer package container 10, or can be made a configuration to be attached to the outside of the outer package container 10 and/or the container 20 by a cord or other means.

The spray composition according to the present invention is formed by containing a propellant and a coloring agent in a common powder type or liquid type foundation cosmetic component (preferred is the liquid type foundation cosmetic component), and for example, includes LPG, cyclomethicone, water, isopropyl palmitate, talc, titanium dioxide, kaolin, squalane, sorbitan isostearate, mica, poly methyl methacrylate, iron oxides, butylene glycol, glyceryl behenate/eicosadioate, pentylene glycol, sodium PCA, phenoxyethanol, silk powder, lauroyl lysine, isobutane, propane, n-butane and the like. A part of these components in the composition can be removed, and conversely it is also possible to add different components.

It is known in the conventional technical field of foundation cosmetics that there are respective reasons for containing these components which compose the composition. The same reasons also apply to the present invention.

As the propellant used in the present invention, those known in the art as the propellant for the spray jet can be utilized without particular limitation. For example, in addition to LPG, included are chlorinated, fluorinated, and chlorinated/fluorinated low molecular weight hydrocarbons, low molecular weight hydrocarbon mixtures (e.g., a mixture of butane, isobutane and propane commercially known as Propellant A46 manufactured by Phillips Chemical Co., which is an affiliate company of Phillips Petroleum Company), ethers and halohydrocarbons, e.g., dimethylether or dichlorodifluoromethane alone or a mixture thereof with dichlorotetrafluoroethane, and the like. Mixtures of hydrocarbon and halohydrocarbon propellants with dinitrogen monoxide can be also employed. Additionally, nitrogen and carbon dioxide are also employed as a jet gas. Those are used at a ratio sufficient to emit the content in the container.

The coloring agents used in the present invention may be those having a particle phase containing pigments/dyes and/or a pearly luster and/or silk powder and/or a filler typically used for cosmetic compositions. The pigments exist at a percentage of 0 to 15% by weight and preferably 8 to 10% by weight with respect to the weight of the final composition in the composition, and may be white or colored inorganic and/or organic matter of a typical size or the size in nanometers. It is possible to include titanium dioxide, zirconium dioxide or cerium dioxide, and zinc oxide, iron oxide or chromium oxide, ferric blue, chromium hydrate, carbon black, ultramarine (aminosilicate polysulfide), manganese pyrophosphate and certain types of metallic powder such as silver or aluminium powder. Also, it is possible to include lakes of calcium, barium, aluminium or zirconium salt, or acidic dyes.

The pearly luster exists at a percentage of 0 to 20% by weight and preferably 8 to 15% by weight in the composition, and can include natural nacre, micas covered with titanium oxide, iron oxide, natural pigments or bismuth oxychloride, and colored titanium micas.

The silk powder can be added in the composition at a percentage of 0 to 30% by weight and preferably 5 to 15% by weight, and it is possible to utilize those where silk is powdered known in the art without particular limitation.

The filler can be added in the composition at a percentage of 0 to 30% by weight and preferably 5 to 15% by weight, and may be inorganic or synthetic, and lamellar or non-lamellar. It is possible to include talc, mica, silica, kaolin, nylon powder (“nylon” is a registered trade mark), polyethylene powder, Teflon (registered trade mark), starch, boron nitride, microspheres of polymer, e.g., EXPANCEL (a product manufactured by Nobel Industries), POKTTRAP (a product manufactured by Dow Corning), and microbeads of silicone resin (e.g., TOSPEARLS, a product manufactured by Toshiba), precipitated calcium carbonate, magnesium carbonate or magnesium carbonate hydrate, or metallic soaps derived from organic carboxylic acid having 8 to 22 carbon atoms.

Also, the composition may contain water soluble or lipid soluble dyes, particularly natural organic dyes, e.g., cochineal carmine, and/or synthetic dyes, e.g., haloacid dyes, azo dyes or anthraquinone dyes. Additionally, it is possible to include inorganic dyes, e.g., copper sulfate.

The pearly luster used in the present invention is also referred to as pearl pigments, and the pearl pigments can be selected from white pearl pigments, e.g., mica covered with titanium or bismuth oxychloride, colored pearl pigments, e.g., mica-titanium covered with iron oxide, particularly mica-titanium covered with iron (III) blue or chromium oxide, mica-titahium covered with the above type organic pigments and pearl pigments, major ingredient of which is bismuth oxychloride.

As the coloring agent of the present invention, dyes may be used, which comprise various organic and inorganic dyestuffs which color the skin. As the organic dyestuffs, there are various types including azo, indigoid, triphenylmethane, anthraquinone and xanthine dyes which are typically designated as coloring agents of blue, brown, green, orange, red, yellow and the like of D & C (a Japanese Standard for drug and cosmetic use) and FD & C (a Japanese Standard for food, drug and cosmetic use). The inorganic dyestuffs are typically insoluble metallic salts of approved dyestuff additives which are called lakes or iron oxide. Suitable dyestuffs are typically those recognized to be safe, and specific examples are red iron oxide, yellow iron oxide, black iron oxide, brown iron oxide, ultramarine, FD & C coloring agents red No. 2, 5, 6, 7, 10, 11, 12, 13, 30 and 34; FD & C yellow No. 5, red No. 3, 21, 27, 28 and 33 aluminium lakes, yellow No. 5, 6 and 10 aluminium lakes, orange No. 5 aluminium lake, blue No. 1 aluminium lake, red No. 6 barium lake, red No. 7 calcium lake, and the like.

The common foundation cosmetic components used in the present invention include one or more components selected from the group consisting of substances which impart an abrasion resistant property and/or transfer resistant property, a co-solubilizer and the mixture thereof. Non-limiting examples of these constituents comprise the following.

Substances which improve the abrasion resistant property or the transfer resistant property, for example, one or more substances which impart the abrasion resistant property and/or the transfer resistant property through film formation or substantive property can be used for the composition of the present invention. Such substances are generally used at approximately 0.5 to 20% by weight as a whole sum.

Such substances include a film forming polymer substance. A concentration of the film forming polymer substance can vary whereas the film forming polymer substance generally exists at a concentration of approximately 0.5 to 20% by mass (e.g., approximately 1 to 15%), preferably approximately 0.5 to 10% by mass, and more preferably approximately 1 to 8% by mass. Preferable polymers form non-adhesive coating film, which can be removed by water using a common lotion for foundation removal or detergents such as soap.

Common foundation cosmetic components used for the present invention comprise a moisturizing agent, humectant, non-volatile oil, emulsifier, preservative, powder substance and constitutive agent or thickening agent. An example of the non-volatile oil is described in U.S. Pat. No. 5,800,816. Such compositions are further selected from, for example, oil/shine regulating active substances, desquamation active substances, anti-acne active substances, anti-inflammatory active substances, skin brightener or lightening active substances, skin sensitizing agents, skin healing components, sunscreens, anti-sunburn agents and vitamins, and derivatives thereof. An effective amount of protective or therapeutic skin care component thereof can be included.

Fat and oil substances, organic solvents, silicone, thickening agents, refrigerants, ultraviolet or broad band light filtration agents, anti-foaming agents, wettable powder, perfumes, preservatives, surfactants, extenders, sequestering agents, anionic, cationic, non-ionic, zwitterionic polymers and mixtures thereof, propulsive agents, alkali agents or acid agents, or cosmetic aids usually used such as any other components typically used in cosmetics may be contained as common foundation cosmetic components used in the present invention.

Among the organic solvents, it is possible to include alcohols and lower polyvalent alcohols such as ethanol, isopropanol, propyleneglycol, glycerine and sorbitol. The fat and oil substance may be made up of oil or wax or a mixture thereof, fatty acid, fatty acid ester, aliphatic alcohol, Vaseline, paraffin, lanolin, hydrogenated lanolin, and acetylated lanolin.

The oil is selected from animal, plant, mineral or synthetic oils, particularly hydrogenated palm oil, hydrogenated lysine oil, Vaseline oil, paraffin oil, Purcellin oil, silicone oil and isoparaffin. The wax is selected from animal, fossil, plant, mineral or synthetic waxes. Particularly, it is possible to include bee wax, carnauba wax, candelilla wax, sugarcane wax, vegetable wax, mineral wax, montan wax, microcrystalline wax, wax and resin of paraffin and silicone.

Fatty acid esters are, for example, isopropyl myristate, isopropyl adipate, isopropyl palmitate, octyl palmitate, benzoate of fatty acid alcohol with C12 to C15 (“Finsolv TN”, a product manufactured by Fintex), myristate alcohol oxypropylated with 3 mol of propylene oxide (“Witconol APM”, a product manufactured by Witco), caprylic acid, and triglyceride of capric acid (“Miglyol 812”, a product manufactured by Huls).

Next, a utilization method of the composition according to the present invention is explained.

After cleaning legs and feet from the thighs to the tips of the toes with a steamed towel before use, the can is shaken 10 times up and down prior to the spray jet, and then an appropriate amount of the content is directly spray-jetted onto skin from the nozzle, which is separated from a user by approximately 20 cm. Next, the content is sufficiently and evenly spread with fingers. This completes a layer having an appearance as if stockings are worn, and it is possible to step out without feeling any embarrassment without stockings being worn.

If the layer is partially broken, it can be easily restored by partially spray-jetting. Thus, if the can in which the composition according to the present invention is housed is carried in a handbag, it is possible to respond to a sudden accident away from home.

Upon returning home, it is necessary to remove the stocking-like layer. As a technique therefor, it is possible to apply common techniques to remove the foundation.

Next, an example of the composition according to the present invention is explained in detail. Example of the composition A configuration and amounts (% by weight) for obtaining a product with a net weight of 50 g are shown.

Mixing elements

| Ingredients | antity (wt %) | Source(*) | Purpose of use |
|---|---|---|---|
| LPG | 35 | JCID | Atomize Gas |
| Cyclomethicone | 13 | JCD | Oil |
| Water | 9 | JCD | |
| Isopropyl Palmitate | 7.8 | JCD | Emollient |
| Talc | 7.2 | JCD | Filler |
| Titanium Dioxide | 6.5 | JCD | White Pigment |
| Kaolin | 5.5 | JCD | Filler |
| Squalane | 5.1 | JCD | Emollient |
| Sorbitan Isostearate | 3.9 | JCID | Emulsifying Agent |
| Poly Methyl | 1.6 | JCID | Filler |
| Methacrylate | | | |
| Iron oxides | 1.3 | JCD | Color Pigment |
| Butylene Glycol | 1.3 | JCD | Moisturizer |
| Glyceryl Behenate/ | 1 | JCID | Gelling Agent |
| Eicosadioate | | | |
| Pentylene Glycol | 0.7 | JCID | Moisturizer |
| Sodium PCA | 0.7 | JCD | Moisturezer |
| Phenoxyethanol | 0.3 | JCID | Preservative |
| Silk Powder | 0.05 | JCID | Filler |
| Lauroyl Lysine | 0.05 | JCD | Filler |

(Note: In the above, JCD and JCID shown by a symbol “*” represent Japanese Standards of Cosmetic Ingredients and Japanese Cosmetic Ingredient Dictionary, respectively.)

[Effects]

When spray-jetting the composition according to the present invention explained above on stocking-less legs, the following effects are obtained.

1) Since texture as if wearing stockings is given without wearing the stockings, there is no embarrassing feeling for stocking-less legs (naked legs).

2) It is possible to make regions below knees look longer as if wearing stockings even when being stocking-less.

3) When wearing stockings, toes are hidden by extremities of the stockings, but the toes are not hidden and are clearly visible by use of spray jet of the composition of the present invention. Thus, when wearing sandal type shoes, the beauty of female toes, particularly the beauty of nail art pedicure, particularly painting, is not spoiled.

4) Since the layer formed by the spray jet of the composition according to the present invention is, for example, a powder layer, there is no stuffy feeling due to the heat. Thus, females are freed from stockings when used in hot regions and hot seasons where females experience pain wearing stockings. Also, there is an advantage of eliminating tiredness because the layer never constricts legs different from common stockings.

5) Since the composition can be provided in a small can or a steel bottle suitable for carrying, it is conveniently portable. Even when the layer is partially broken, it is possible to be easily fixed.

1. A unit forming a stocking-like layer on stocking-less legs, which is composed of a combination of a container formed in a can or a steel bottle in which a coloring agent selected from pigments, dyes, pearly lusters, silk powder and fillers, a cosmetic and a propellant are housed as an aerosol and an illustrative medium made up of descriptive text, images and/or illustrative voice which informs users that a stocking-like layer is formed by directly spray-jetting the above coloring agent along with the cosmetic on stocking-less legs.

2. The unit forming a stocking-like layer on stocking-less legs according to claim 1, wherein the illustrative medium is formed on an entirety or a part of peripheral sides of an outer package.

3. The unit forming a stocking-like layer on stocking-less legs according to claim 1, wherein the illustrative medium is formed on a peripheral side of the container in which the composition to be spray-jetted is housed.

4. The unit forming a stocking-like layer on stocking-less legs according to claim 1, wherein the illustrative medium is formed on an entirety or a part of a paper piece, plastic plate, wooden plate or metallic plate attached to the container.
